(19) United States
(12) Patent Application Publication
(10) Pub. No.: US 2020/0026396 A1
(43) Pub. Date: Jan. 23, 2020

(54) MOBILE TERMINAL APPARATUS AND METHOD FOR CONTROLLING DISPLAY OF THE MOBILE TERMINAL APPARATUS

(71) Applicant: SHARP KABUSHIKI KAISHA, Osaka (JP)

(72) Inventors: KOHICHI MURAKAMI, Osaka (JP); YASUHIRO NAKAI, Osaka (JP); KOHJI KATAMOTO, Osaka (JP); YASUTOMO HAYANO, Osaka (JP); MASAO SAEDA, Osaka (JP)

(21) Appl. No.: 16/512,892

(22) Filed: Jul. 16, 2019

(30) Foreign Application Priority Data
Jul. 23, 2018 (JP) 2018-137602

(51) Int. Cl. G06F 3/0482; H04N 1/00; G06F 3/12; G06F 3/0484

(52) U.S. Cl. CPC G06F 3/0482; H04N 1/00307; G06F 3/1288; H04N 2201/0096; G06F 3/1236; G06F 3/04847; G06F 3/1204

(57) ABSTRACT

A mobile terminal apparatus and a method for controlling display of the mobile terminal apparatus are display a plurality of thumbnail images in a thumbnail display area of a display screen, to receive an operation to choose a thumbnail image in the thumbnail display area in which the plurality of thumbnail images are displayed, to display an enlarged image of the chosen thumbnail image in an enlarged display area of the display screen, with the chosen thumbnail image kept displayed, to receive an operation to change a size of the enlarged display area on the display screen, and to increase an enlargement ratio of the enlarged image to fit the size of the enlarged display area when increasing the size of the enlarged display area.

### BACKGROUND

### 1. Field

The present disclosure relates to a mobile terminal apparatus and a method for controlling display of the mobile terminal apparatus.

### 2. Description of the Related Art

The rate of utilization of mobile terminal apparatuses, such as smartphones, personal digital assistants (PDAs), and tablet personal computers (PCs), has recently increased due to improvement in camera functions and display screen performance.

In such mobile terminal apparatuses, a plurality of thumbnail images corresponding to a plurality of image data, such as photographic data, can be displayed on a display screen so as to be chosen on the display screen. In the mobile terminal apparatuses, image data corresponding to a thumbnail image chosen from the plurality of thumbnail images displayed on the display screen is specified. (see Japanese Unexamined Patent Application Publication No. 2008-146453 and No. 2010-198212)

The choice of the thumbnail image in the known mobile terminal apparatuses in the related art have the following issues.

The mobile terminal apparatuses have a continuous shooting function and a function of extracting a photographic image from a moving image as standard. This leads to an increase in a situation where a large number of similar image data items are stored, and the best thumbnail image is chosen from thumbnail images corresponding to these image data items. It is however difficult to choose the best thumbnail image from a plurality of thumbnail images. For example, if an image portion serving as information for making a decision for choice is small, it is difficult to distinguish the features of the image portion (specifically, the facial expression of a person with eyes closed, etc.).

The mobile terminal apparatuses further have a function of displaying an enlarged image of the chosen thumbnail image. In this case, the enlarged image is sometimes displayed together on a thumbnail screen on which the thumbnail image is displayed (for example, Japanese Unexamined Patent Application Publication No. 2008-146453 and No. 2010-198212) or, in some cases, the enlarged image is moved to an enlarged-image dedicated screen on which only an enlarged image is to be displayed. However, in the case where the enlarged image is displayed together on the thumbnail screen, the size of the enlarged image is limited, so that it is still difficult zo check the details of the image portion in the thumbnail image. In the case where the enlarged image is moved to the enlarged-image dedicated screen, an operation for moving the enlarged image from the enlarged-image dedicated screen back to the thumbnail screen is complicated, although the details of the image portion of the thumbnail image can be checked, so that the operability is low.

It is desirable to provide a mobile terminal apparatus in which the details of an image part in a thumbnail image can be checked with good operability, and a method for controlling display of the mobile terminal apparatus.

### SUMMARY

The present disclosure provides a mobile terminal apparatus and a method for controlling display of the mobile terminal apparatus described below.

### (1) Mobile Terminal Apparatus

According to a first aspect of the disclosure, there is provided a mobile terminal apparatus including a display unit including a display screen, a display control program for displaying a plurality of thumbnail images respectively corresponding to a plurality of image data on the display screen to allow the plurality of thumbnail images to be chosen on the display screen, a control unit, and a storage unit storing the plurality of image data corresponding to the plurality of thumbnail images. The display control program causes the control unit to execute a first control step of displaying the plurality of thumbnail images in a thumbnail display area of the display screen, a second control step of receiving an operation to choose a thumbnail image in the thumbnail display area in which the plurality of thumbnail images are displayed, a third control step of displaying an enlarged image of the chosen thumbnail image in an enlarged display area of the display screen, with the chosen thumbnail image kept displayed, a fourth control step of receiving an operation to change a size of the enlarged display area on the display screen, and a fifth control step of increasing an enlargement ratio of the enlarged image to fit the size of the enlarged display area when increasing the size of the enlarged display area.

### 2. Method for Controlling Display of Mobile Terminal Apparatus

According to a second aspect of the disclosure, there is provided a method for controlling display of a mobile terminal apparatus. The method includes a first control step of displaying the plurality of thumbnail images in a thumbnail display area of the display screen, a second control step of receiving an operation to choose a thumbnail image in the thumbnail display area in which the plurality of thumbnail images are displayed, a third control step of displaying an enlarged image of the chosen thumbnail image is an enlarged display area of the display screen, with the chosen thumbnail image kept displayed, a fourth control step of receiving an operation to change a size of the enlarged display area on the display screen, and a fifth control step of increasing an enlargement ratio of the enlarged image to fit the size of the enlarged display area when increasing the size of the enlarged display area.

### BRIEF DESCRIPTION OF THE DRAWINGS

FIG. 1 is a block diagram illustrating the hardware configuration of a mobile terminal apparatus and an image forming apparatus according to an embodiment of the present disclosure;

FIG. 2 is a block diagram illustrating the hardware configuration of the mobile terminal apparatus illustrated in FIG. 1;

FIG. 3 is a schematic front view of the mobile terminal apparatus illustrating a first screen;

FIG. 4 is a schematic front view of the mobile terminal apparatus illustrating a second screen;

FIG. 5 is a schematic front view of the mobile terminal apparatus illustrating a third screen;

FIG. 6 is a schematic front view of the mobile terminal apparatus illustrating a fourth screen;

FIG. 7 is a schematic front view of the mobile terminal apparatus illustrating a fifth screen;

FIG. 8 is a schematic front view of the mobile terminal apparatus illustrating a sixth screen;

FIG. 9 is a schematic front view of the mobile terminal apparatus illustrating an example of a preview displayed on the display screen of the display unit;

FIG. 10 is a schematic front view of the mobile terminal apparatus illustrating another example of the preview displayed on the display screen of the display unit;

FIG. 11 is a schematic front view of the mobile terminal apparatus illustrating still another example of the preview displayed on the display screen of the display unit;

FIG. 12 is a schematic front view of the mobile terminal apparatus illustrating still another example of the preview displayed on the display screen of the display unit; and

FIG. 13 is a schematic front view of the mobile terminal apparatus illustrating still another example of the preview displayed on the display screen of the display unit.

### DESCRIPTION OF THE EMBODIMENTS

Embodiments of the present disclosure will be described hereinbelow with reference to the drawings. In the following description, like parts are identified by the same reference signs. The names and functions are also the same. Thus, the detailed descriptions thereof will not be repeated.

### Configuration of Image Forming System

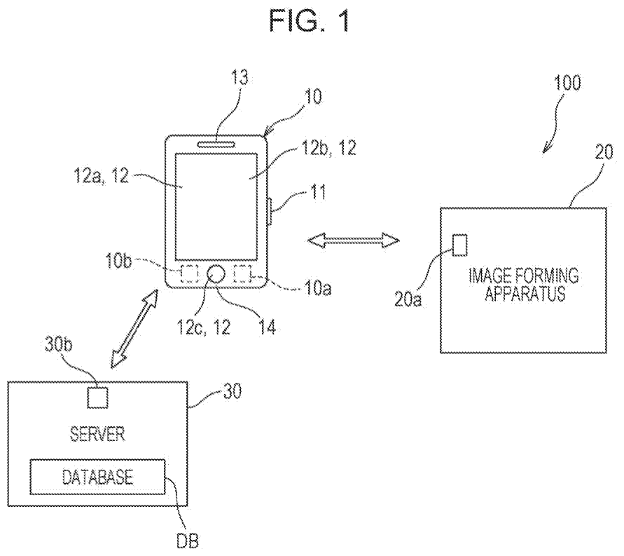

FIG. 1 is a schematic configuration diagram illustrating an example of a mobile terminal apparatus 10 and an image forming apparatus 20 according to an embodiment of the present disclosure.

An image forming system 100 illustrated in FIG. 1 includes one or more mobile terminal apparatuses 10 and one or more image forming apparatuses 20. FIG. 1 illustrates one mobile terminal apparatus 10. An example of the image forming apparatus 20 is a multifunctional machine installed at an installation site of a convenience store.

The mobile terminal apparatus 10 and the image forming apparatus 20 respectively include short-range wireless communication units 10a and 20a for short-range wireless communication so as to communicate with each other. Examples of the short-range wireless communication include wireless local area network (LAN) communication and wireless personal area network (PAN) communication. An example of the wireless LAN communication is wireless LAN communication based on the IEEE802.11 standard, typified by the Wi-Fi standard. An example of the wireless PAN communication is wireless PAN communication based on the IEEE802.15 standard, typified by the Bluetooth® standard. In this example, the wireless communication units 10a and 20a are communication interfaces based on the IEEE802.11 standard.

The mobile terminal apparatus 10 communicates with a server 30 outside the image forming system 100 via a predetermined communication tool, such as the Internet. The mobile terminal apparatus 10 and the server 30 respectively include wide-area wireless communication units 10b and 30b so as to communicate with each other. The server 30 stores image data uploaded from the mobile terminal apparatus 10 in a database DB. The mobile terminal apparatus 10 downloads the image data stored in the server 30. The image forming system 100 may include the server 30.

Examples of the communication tool for the mobile terminal apparatus 10 and the server 30 include a communication tool via the Internet based on a mobile phone communication standard and a communication tool via the wireless LAN communication based on the IEEE802.11 standard.

The mobile terminal apparatus 10 of the image forming system 100 illustrated in FIG. 1 includes a power button 11, a user interface 12 including a display unit 12a (a display panel), a touch operation unit 12b (a touch panel), and an operation button 12c, a telephone receiving unit 13, and a telephone transmitting unit 14. The power button 11 and the operation button 12c are hardware-based operation buttons. The other operation buttons function as software using the touch operation unit 12b on the display unit 12a.

### Hardware Configuration of Mobile Terminal Apparatus

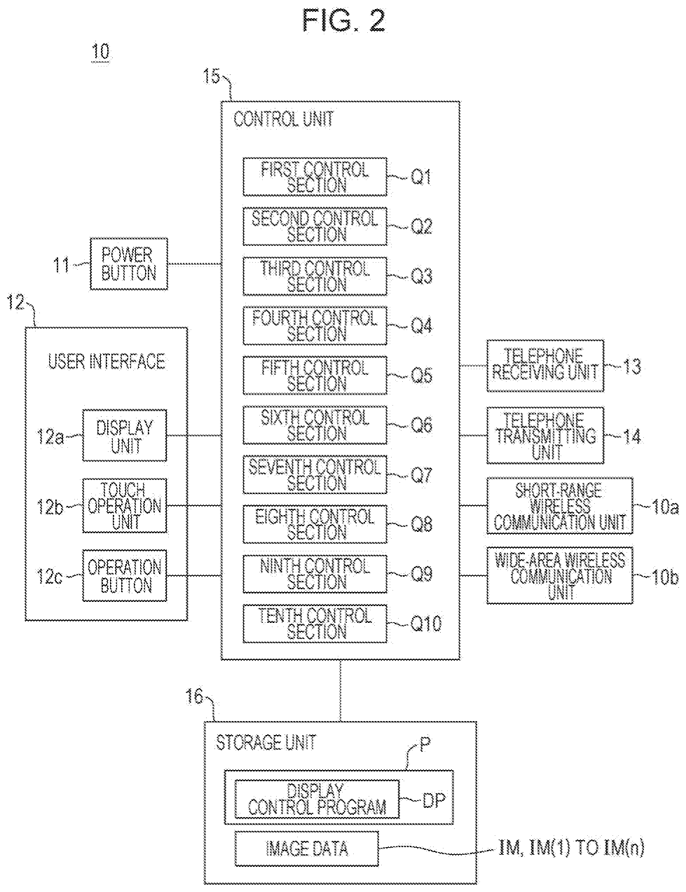

FIG. 2 is a block diagram illustrating the hardware configuration of the mobile terminal apparatus 10 illustrated in FIG. 1.

As illustrated in FIG. 2, the mobile terminal apparatus 10 is a multifunctional mobile communication terminal apparatus (in this example, a smartphone) and further includes a control unit 15 (an example of a computer), a storage unit 16, the short-range wireless communication unit 10a, and the wide-area wireless communication unit 10b. The power button 11, the display unit 12a, the touch operation unit 12b, the operation button 12c, the telephone receiving unit 13, the telephone transmitting unit 14, the storage unit 16, the short-range wireless communication unit 10a, and the wide-area wireless communication unit 10b are electrically connected to the control unit 15.

### User Interface

The user interface 12 includes an output unit, such as the display unit 12a, and an input unit, such as the touch operation unit 12b and the operation button 12c. The user interface 12 can typically control start-up of a display control program DP and display image data.

### Control Unit

The control unit 15 is a computer including a central processing unit (CPU). The control unit 15 executes a program P including the display control program DP, which is stored (installed) in the storage unit 16 in advance, to implement various functions necessary for the control unit 15. The control unit 15 executes various processes by loading the program P, such as the display control program DP, stored in advance in a read only memory (ROM) of the storage unit 16 onto a random access memory (RAM) of the storage unit 16 and executing the program P.

The control unit 15 controls transmission and reception of data during communication and various input and output operations and computational processing operations. Upon receiving a touch operation on the touch operation unit 12b on the display unit 12a using a user's finger, the control unit 15 reads the operation position with the touch operation unit 12b, determines that an operation button displayed on the operation position on the display unit 12a is pressed, and performs processing.

### Storage Unit

The storage unit 16 includes a non-volatile memory, such as a RAM, and a volatile memory, such as a ROM. The storage unit 16 is subjected to write control in which information is written and read control in which information is read under instructions from the control unit 15. In this example, the storage unit 16 is a mass storage such as a flash memory.

The storage unit 16 stores (installs) the program P, such as the display control program DP, in advance. In this example, the display control program DP is a program, or a so-called application, for use in a multifunctional mobile communication terminal apparatus, such as a smartphone. The display control program DP is installed in advance or by being downloaded from a program server (not illustrated) via a communication tool, such as the Internet.

The storage unit 16 also stores image data IM, such as photographic data captured using a camera function of the mobile terminal apparatus 10 or photographic data taken from an external storage medium.

### Short-Range Wireless Communication Unit

The short-range wireless communication unit 10a is capable of communication based on the same communication protocol as the communication protocol of the short-range wireless communication unit 20a of the image forming apparatus 20.

### Wide-Area wireless Communication Unit

The wide-area wireless communication unit 10b is capable of communication based on the same communication protocol as the communication protocol of the wide-area wireless communication unit 30b of the server 30. The wide-area wireless communication unit 10b receives the image data IM stored in the server 30 from the server 30.

### Software Configuration of Mobile Terminal Apparatus

The control unit 15 functions as a unit including a first control section Q1, a second control section Q2, a third control section Q3, a fourth control section Q4, and a fifth control section Q5. In other words, the display control program DP causes the control unit 15 to execute a first control step corresponding to the first control section Q1, a second control step corresponding to the second control section Q2, a third control step corresponding to the third control section Q3, a fourth control step corresponding to the fourth control section Q4, and a fifth control step corresponding to the fifth control section Q5.

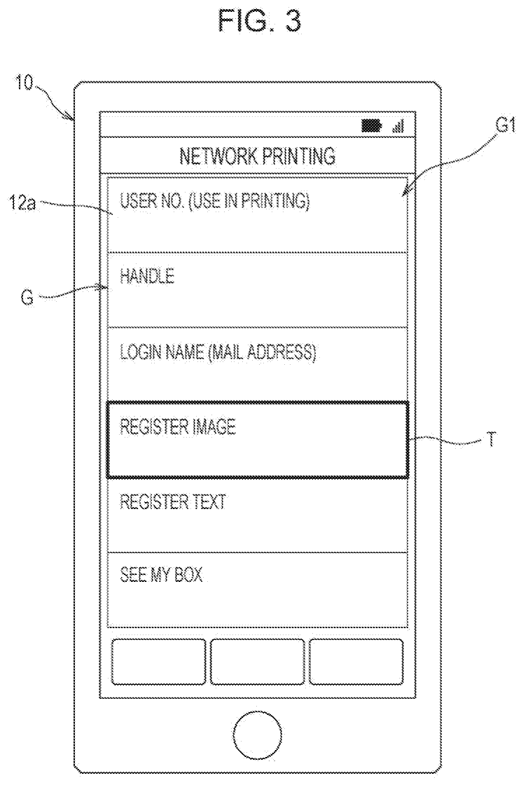

FIGS. 3 to 8 are schematic front views of the mobile terminal apparatus 10, illustrating transition of display examples displayed on a display screen G of the display unit 12a. FIGS. 3 to 8 respectively illustrate a first screen G1 to a sixth screen G6.

The display control program DP is a display control program for displaying a plurality of thumbnail images SN(1) to SN(n) corresponding to a plurality of image data IM(1) to IM(n) (n is an integer greater than or equal to 2) on the display screen G so that the plurality of thumbnail images SN(1) to SN(n) can be chosen on the display screen G. The storage unit 16 stores the plurality of image data IM(1) to IM(n) respectively corresponding to the plurality of thumbnail images SN(1) to SN(n). The display unit 12a includes the display screen G.

### First Embodiment

### First Control Step

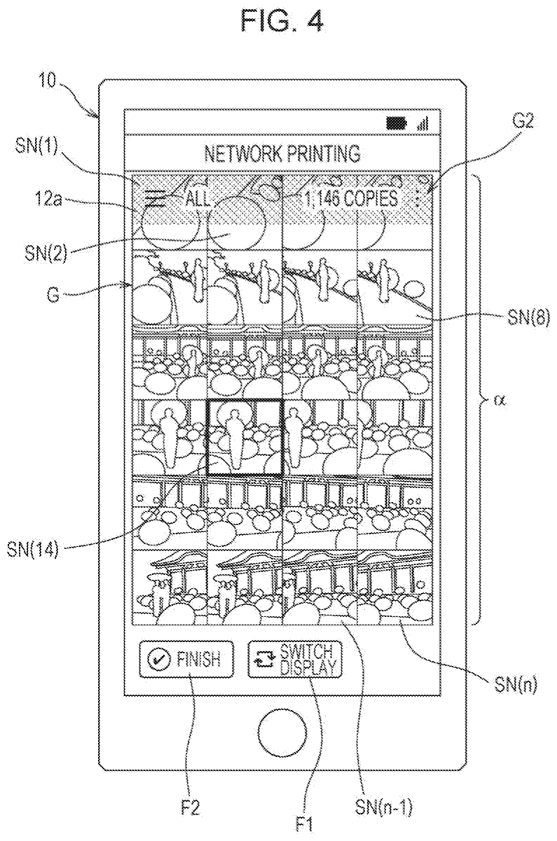

At the first control step, the control unit 15 displays the plurality of thumbnail images SN(1) to SN(n) on a thumbnail display area α of the display screen G (see FIG. 4). Specifically, the control unit 15 launches the display control program DP according to a user operation to launch the display control program DP to display a first screen G1 (an image choice screen) (see FIG. 3). Next, the control unit 15 displays a second screen G2 (a thumbnail-image choice screen (see FIG. 4) according to a user operation to choose an image registration button (“Register Image” button T). In the case where the thumbnail images SN(1) to SN(n) are not fitted in the display screen G, the control unit 15 displays the next screen upon receiving an operation on [Display Switch] button F1.

### Second Control Step

At the second control step, the control unit 15 receives a choosing operation on the display screen G in which the plurality of thumbnail images SN(1) to SN(n) are displayed (in this example, n=24: 6×4) (see FIG. 4). Specifically, the control unit 15 receives an operation to choose a thumbnail image SN(i) (i is an integer from 1 to n in this example, i=14) according to a user's choice operation on the thumbnail images SN(1) to SN(n).

### Third Control Step

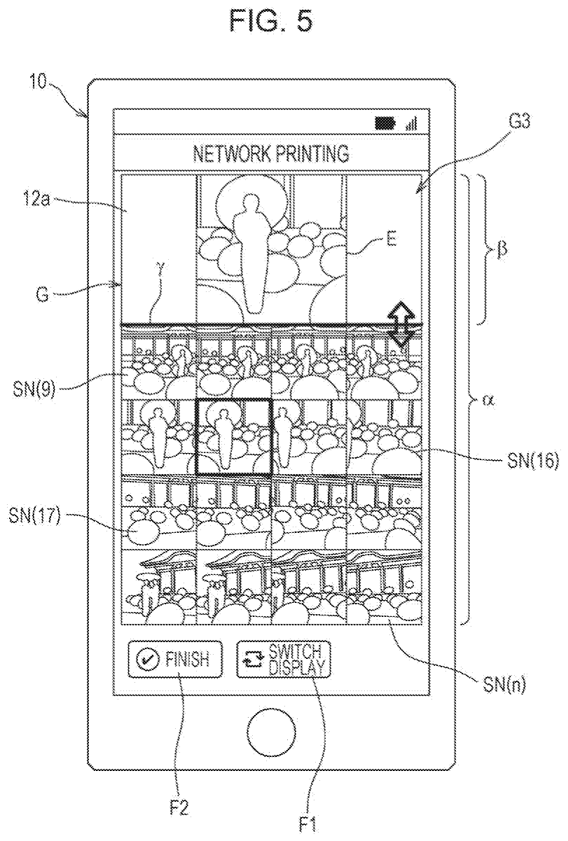

At the third control step, the control unit 15 displays an enlarged image E of the chosen thumbnail image SN(i) in an enlarged display area β of the display screen G with the chosen thumbnail image SN(i) kept displayed (see FIG. 5). Specifically, when one of the central thumbnail image SN(9) to SN(16) (corresponding to two rows) is chosen the control unit 15 displays the enlarged display area β in the area of the upper thumbnail images SN(1) to SN(8) (corresponding to two rows) or the area of the lower thumbnail images SN(17) to SN(24) (corresponding to two rows) on the display screen G. When one of the upper thumbnail image SN(1) to SN(8) is chosen, the control unit 15 displays the enlarged display area β in the area of the central thumbnail images SN(9) to SN(16) or the area of the lower thumbnail images SN(17) to SN(24) on the display screen G. When one of the lower thumbnail image SN(17) to SN(24) is chosen, the control unit 15 displays the enlarged display area β in the area of the central thumbnail images SN(9) to SN(16) or the area of the upper thumbnail images SN(1) to SN(8) on the display screen G.

### Fourth Control Step

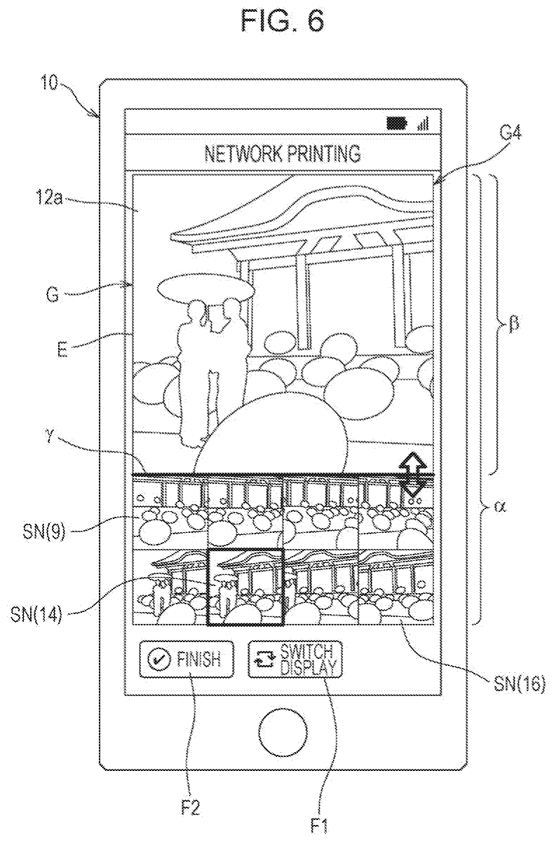

At the fourth control step, the control unit 15 receives an operation to change the size of the enlarged display area β of the display screen G (see FIG. 6). Specifically, when a touch operation on a display area line γ of the enlarged display area β adjacent to the thumbnail display area α moves toward the thumbnail display area α, the control unit 15 increases the size of the enlarged display area β. When the touch operation on the display area line γ moves opposite to the thumbnail display area α, the control unit 15 decreases the size of the enlarged display area β.

### Fifth Control Step

When increasing the size of the enlarged display area β is, then at the fifth control step, the control unit 15 increases the magnification ratio of the enlarged image E to fit the size of the enlarged display area β (see FIG. 6). Specifically, the control unit 15 enlarges the enlarged image E until the size of the enlarged image E reaches a predetermined size (for example, the lateral size of the display screen G).

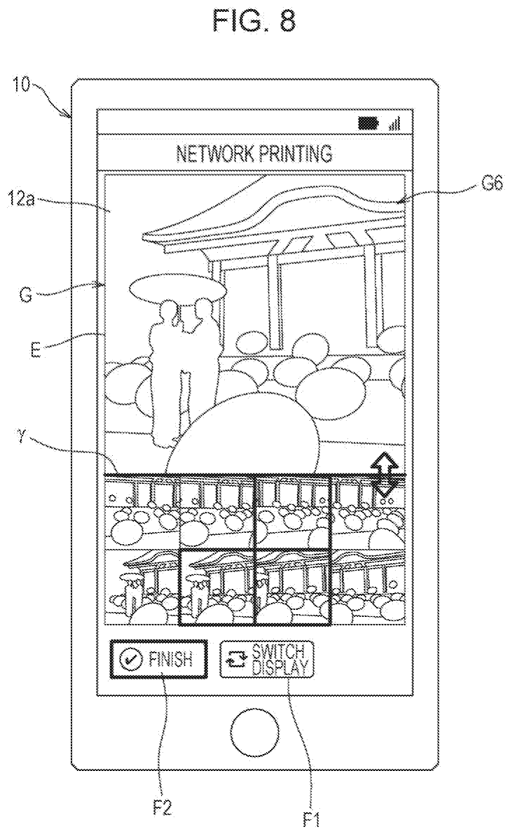

Thereafter, when [Finish] button F2 (see FIG. 8) is touched by the user, the control unit 15 accepts the chosen thumbnail image SN(i) and transmits image data IM corresponding to the thumbnail image SN(i) to the image forming apparatus 20 via wireless communication.

The image forming apparatus 20 prints the image data IM transmitted from the mobile terminal apparatus 10 after print setting.

### Description of the Present Embodiment

According to the present embodiment, the control unit 15 displays the plurality of thumbnail images SN(1) to SN(n) in the thumbnail display area α of the display screen G (the first control step: see FIG. 4) and receives a choosing operation in the thumbnail display area α in which the plurality of thumbnail images SN(1) to SN(n) are displayed (the second control step: see FIG. 4). The user chooses (touches) a desired thumbnail image SN(i) from among the plurality of thumbnail images SN(1) to SN(n) displayed in the thumbnail display area α of the display screen G (see FIG. 4). The control unit 15 displays the enlarged image E of the chosen thumbnail image SN(i) in the enlarged display area β of the display screen G, with the chosen thumbnail image SN(i) kept displayed (the third control step: see FIG. 5) and receives an operation to change the size of the enlarged display area β of the display screen G (the fourth control step: see FIG. 5). When the user wants to further enlarge the enlarged image E of the thumbnail image SN(i) displayed in the enlarged display area β of the display screen G, the user performs an enlarging operation on the enlarged display area β. Then, the control unit 15 increases the size of the enlarged display area β (the fifth control step: see FIG. 6). At that time, the control unit 15 increases the enlargement ratio of the enlarged image E to fit the size of the enlarged display area β. This allows the enlarged image E to be displayed all over the enlarged display area β. This allows highly operable checking of the details of the image part of the thumbnail image SN(i).

When the user wants to return the enlarged image E of the thumbnail image SN(i) to the original size, the user performs a size-reducing operation on the enlarged display area β. Then, the control unit 15 reduces the size of the enlarged display area β to the original size (the fifth control step: see FIG. 5). At this time, the control unit 15 decreases the enlargement ratio of the enlarged image E to fit the size of the enlarged display area β.

### Second Embodiment

In the present embodiment, the control unit 15 decreases the number of thumbnail images displayed by a number corresponding to an increase in the size of the enlarged display area β (the fifth control step: see FIG. 6). This allows the display size of the thumbnail image to be kept even if the size of the enlarged display area β is increased. This allows the user to easily recognize the thumbnail image.

### Third Embodiment

In the present embodiment, the control unit 15 displays the enlarged display area β on the thumbnail display area α in an overlapping manner (the third control step: see FIGS. 5 and 6). This allows the enlarged display area β to be easily displayed on the display screen G.

### Fourth Embodiment

In the present embodiment, the control unit 15 receives an operation to change the size of the enlarged display area β of the display screen G, with the chosen thumbnail image SN(i) kept displayed in the thumbnail display area α (the fourth control step: see FIG. 6). This allows the enlarged display area β to be enlarged, with the chosen thumbnail image SN(i) kept displayed in the thumbnail display area α. This allows the chosen thumbnail image SN(i) to be kept even when the enlarged display area β is enlarged.

### FIFTH EMBODIMENT

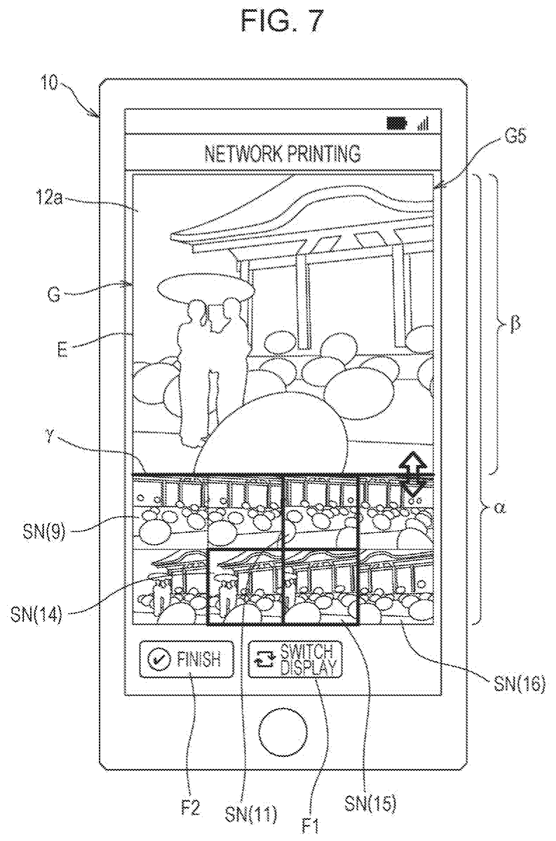

In the present embodiment, the control unit 15 holds a state in which a thumbnail image SN(j) is chosen (j is an integer from 1 to n other than i, in this example, j=11, 15) (the second control step: see FIG. 7). At this time the user touches the thumbnail image SN(j) once again. Then the control unit 15 cancels the choice of the chosen thumbnail image SN(i). The control unit 15 receives an operation to change the size of the enlarged display area β of the display screen G, with the chosen thumbnail image SN(i) and the held thumbnail image SN(j) kept displayed in the thumbnail display area α (the fourth control step).

This allows the enlarged display area β to be enlarged, with the chosen thumbnail image SN(i) and the held thumbnail image SN(j) kept displayed in the thumbnail display area α. Thus, the chosen thumbnail image SN(i) and the held thumbnail image SN(j) can be held even when the enlarged display area β is enlarged.

Alternatively, the control unit 15 may be configured, when the user touches the thumbnail image SN(i) on the display screen G, to cancel the choice of the thumbnail image SN(j) chosen before, to display the enlarged image E of the thumbnail image SN(i) chosen this time in the enlarged display area β of the display screen G, with the thumbnail image SN(i) kept displayed (the third control step), and to receive an operation to change the size of the enlarged display area β of the display screen G (the fourth control step).

### Sixth Embodiment

The size of the display screen G varies depending on the model of the mobile terminal apparatus 10, so that it is difficult to specify the resolution of the enlarged image E in advance. This makes the process of enlarging the enlarged image E corresponding to the thumbnail image complicated. In particular, an apparatus provided with a control unit 15 whose processing speed is low takes a long processing time, which makes it difficult to smoothly display the enlarged image E at the time of enlargement. This is particularly prominent in the case where the mobile terminal apparatus 10 in which the display control program DP is installed is a standard apparatus (for example, ANDROID®).

In this respect, the control unit 15 of the present embodiment specifies a predetermined largest display size for the enlarged display area β so that the enlarged display area β does not exceed the largest display size (the fourth control step).

This allows the resolution of the enlarged image E to be specified in advance. This makes it easy to enlarge the enlarged image E corresponding to the thumbnail image SN(i). In particular, this reduces the processing time even if the processing speed of the control unit 15 is low, allowing the enlarged image E to be smoothly displayed at the time of enlargement. The mobile terminal apparatus 10 has information on the size of the display screen G of the mobile terminal apparatus 10 itself. The control unit 15 uses the information on the size of the display screen G of the mobile terminal apparatus 10 itself in the display control program DP.

### Seventh Embodiment

In the present embodiment, when decreasing the size of the enlarged display area β, the control unit 15 decreases the enlargement ratio of the enlarged image E to fit the size of the enlarged display area β (the fifth control step). This allows the enlarged image E to be displayed all over the enlarged display area β.

### Eighth Embodiment

In the present embodiment, the control unit 15 increases the number of thumbnail images displayed by a number corresponding to a decrease in the size of the enlarged display area β (the fifth control step: see FIG. 5). This allows the number of thumbnail images displayed to be increased when the size of the enlarged display area β is reduced.

### Ninth Embodiment

The size of the display screen G varies depending on the model of the mobile terminal apparatus 10, so that a desired number of thumbnail images SN(1) to SN(n) may not be displayed on the display screen G, or the thumbnail images SN(1) to SN(n) may be displaced depending on the size of the thumbnail images SN(1) to SN(n). This is particularly prominent in the case where the mobile terminal apparatus 10 is a standard apparatus.

In this respect, the control unit 15 of the present embodiment sets the size and the positions of the thumbnail images SN(1) to SN(n) to fit the size of the display screen G (the first control step: see FIG. 4). Specifically, the control unit 15 sets the thumbnail images SN(1) to SN(n) larger as the display screen G is larger and/or sets the positions of the thumbnail images SN(1) to SN(n) to positions where the user can recognize the thumbnail images SN(1) to SN(n) more easily. The control unit 15 sets the thumbnail images SN(1) to SN(n) smaller as the display screen G is smaller and/or sets the positions of the thumbnail images SN(1) to SN(n) to positions where the user can recognize the thumbnail images SN(1) to SN(n) more easily. This allows a desired number of thumbnail images SN(1) to SN(n) to be displayed within the display screen G regardless of the size of the display screen G of the mobile terminal apparatuses 10 of various types, so that the thumbnail images SN(1) to SN(n) are not displaced.

### Tenth Embodiment

The size of the display screen G varies depending on the model of the mobile terminal apparatus 10, so that, depending on the number of thumbnail images SN(1) to SN(n) displayed, the thumbnail images SN(1) to SN(n) may be too small for the user to recognize the thumbnail images SN(1) to SN(n). This is particularly prominent in the case where the mobile terminal apparatus 10 is a standard apparatus.

In this respect, the control unit 15 of the present embodiment sets the number of thumbnail images SN(1) to SN(n) displayed to fit the size of the display screen G (the first control step). Specifically, the control unit 15 sets the number of thumbnail images SN(1) to SN(n) displayed larger as the display screen G is smaller. This makes the thumbnail image SN(i) to a size easy for the user to recognize regardless of the size of the display screen G of the mobile terminal apparatuses 10 of various types.

### Eleventh Embodiment

In the present embodiment, the control unit 15 sets a predetermined largest display size of the thumbnail display area α to fit the size of the display screen G (the fourth control step: see FIG. 5). This allows the thumbnail images SN(1) to SN(n) to be displayed in the thumbnail display area α in an optimal state so that the user can easily recognize the thumbnail images SN(1) to SN(n) regardless of the size of the display screen G of the mobile terminal apparatuses 10 of various types.

### Twelfth Embodiment

In the present embodiment, the control unit 15 functions as a unit further including a sixth control section Q6. In other words, the display control program DP causes the control unit 15 to execute steps further including a sixth control step corresponding to the sixth control section Q6.

At the sixth control step, the control unit 15 transmits image data IM corresponding to the chosen thumbnail image SN(i) to the image forming apparatus 20. This allows the image data IM in the mobile terminal apparatus 10 to be received by the image forming apparatus 20, allowing an image based on the image data IM to be printed by the image forming apparatus 20.

### Thirteenth Embodiment

Some of the image forming apparatuses 20, 21, . . . (the image forming apparatuses 21 . . . are not illustrated) operating in the field can print on sheets of Japanese standard L size [89 mm×127 mm] and sheets of Japanese standard 2L size [127 mm×178 mm] or more, others can only print on sheets of A4size [210 mm×297 mm] or sheets of A4 size or more. Thus, the image forming apparatuses 20, 21, . . . have different functions. Thus, when the mobile terminal apparatus 10 transmits image data IM corresponding to the chosen thumbnail image SN(i) to the image forming apparatus 20, an image to be formed (a target image) based on the image data IM is previewed on the display screen of the operation unit of the image forming apparatus 20 according to the function of the image forming apparatus 20. Because of this, part of the image data IM may not be displayed depending on the size (aspect ratio) of the image data IM transmitted from the mobile terminal apparatus 10.

For example, if the image size of the image data IM corresponding to the chosen thumbnail image SN(i) is L size, while the image forming apparatus 20 to which the image data IM is transmitted does not have a function for-printing L-size sheets, the image data IM is previewed on the display screen of the image forming apparatus 20, with part of the image data IM missing. For this reason, after transmitting the image data IM from the mobile terminal apparatus 10 to the image forming apparatus 20, the user has to process the image data IM to fit the function provided for the image forming apparatus 20 with the mobile terminal apparatus 10 and transmit the processed image data IM to the image forming apparatus 20 again. Thus, the user has to transmit the image data IM to the image forming apparatus 20 twice, which takes much time and labor for the transmission operation.

In this respect, the control unit 15 of the present embodiment functions as a unit further including a seventh control section Q7 and an eighth control section Q8. In other words, the display control program DP causes the control unit 15 to execute a seventh control step corresponding the seventh control section Q7 and an eighth control step corresponding to the eighth control section Q8.

At the seventh control step, the control unit 15 receives function data on the functions of the image forming apparatus 20 from the image forming apparatus 20. At the eighth control step, the control unit 15 previews the target image based on the image data IM on the display screen G of the display unit 12a according to the function provided for the image forming apparatus 20.

This allows the control unit 15 of the mobile terminal apparatus 10 to preview the target image based on the image data IM on the display screen G of the display unit 12a according to the function of the image forming apparatus 20. This allows the user to process the image data IM with the mobile terminal apparatus 10 so as to fit the function of the image forming apparatus 20 before transmitting the image data IM to the image forming apparatus 20. Thus, the user can transmit the image data IM in the mobile terminal apparatus 10 to the image forming apparatus 20 at one time, which can save the time and labor for the transmission operation.

An example of the installed function is a function of forming images on sheets of a preset specified size (L-size, 2L-size, or A4-size). The control unit 15 previews a target image based on the image data IM on the display screen G of the display unit 12a according to the specified size (the eighth control step).

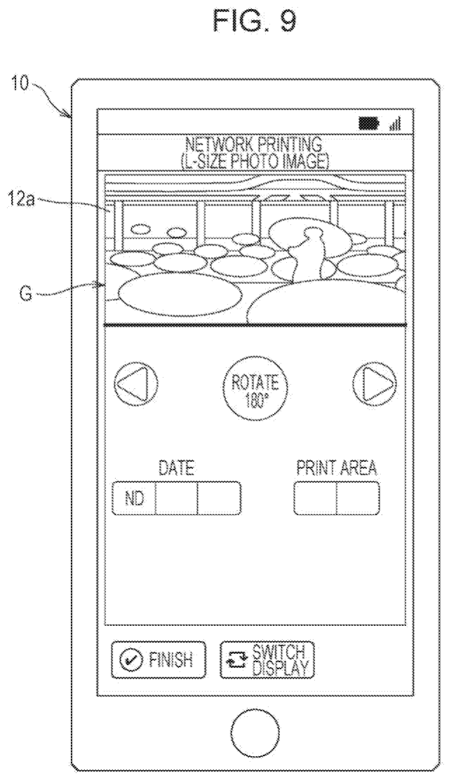

FIGS. 9 to 13 are schematic front views of the mobile terminal apparatus 10 illustrating preview examples displayed on the display screen G of the display unit 12a.

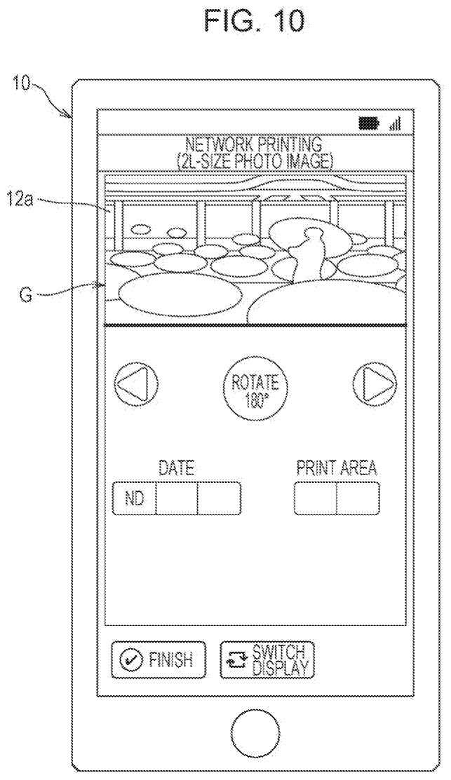

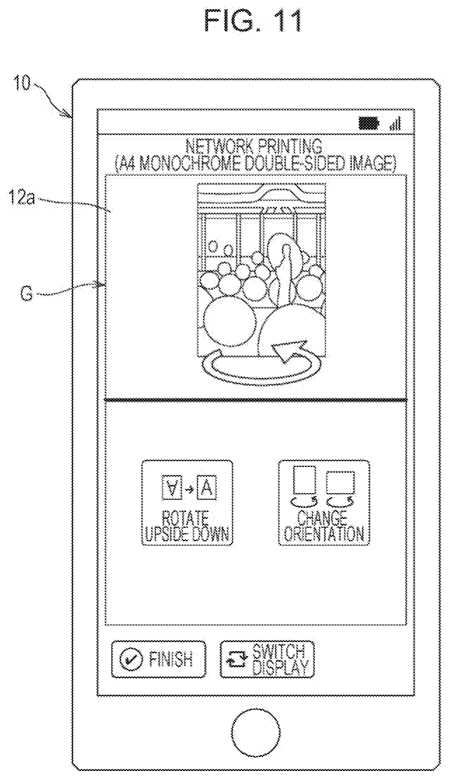

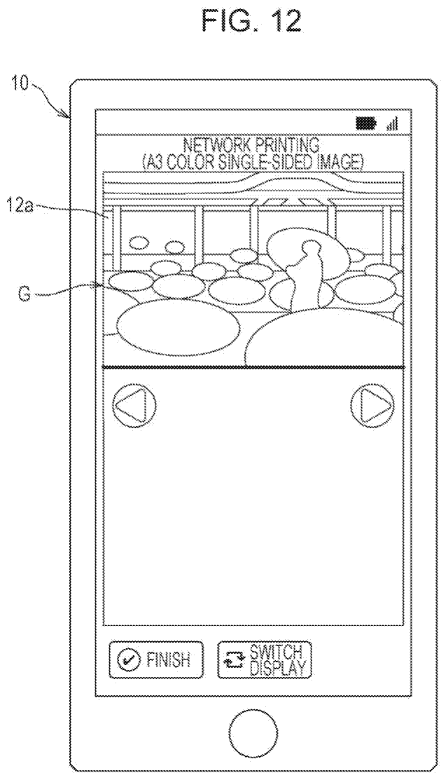

For example, the control unit 15 displays a preview of a photographic image based on the image data IM on the display screen G of the display unit 12a according to L size or 2L size (see FIG. 9 or FIG. 10). The control unit 15 displays a preview of a monochrome double-sided image or a color single-sided image based on the image data IM on the display screen G of the display unit 12a according to A4 size or A3 size (see FIG. 11 or FIG. 12). In the case where multiple thumbnail images are chosen, the next image data IM is previewed by touching a forward button on the display screen G, and the previous image data IM is previewed by touching a backward button on the display screen G.

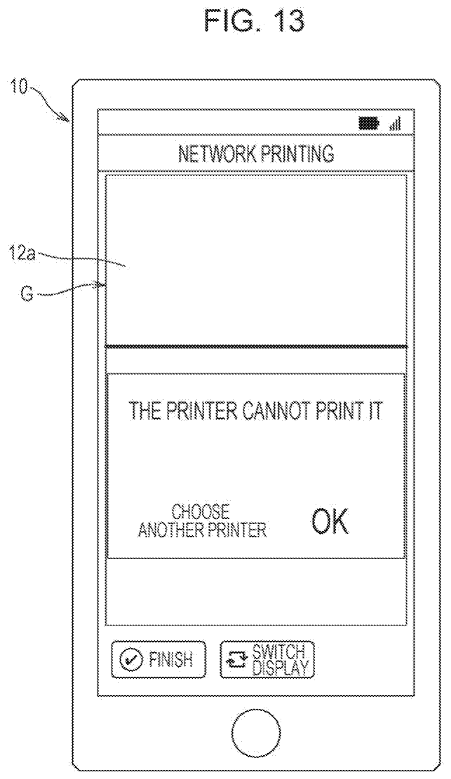

If the image based on the image data IM corresponding to the chosen thumbnail image SN(i) is an L-size photographic image, a 2L-size photographic image, an A4-size monochrome double-sided image, or an A3-size color single-sided image, but the image forming apparatus 20 to which the image data IM is transmitted does not have a support function, the control unit 15 displays a message that the image data IM is not printed by the image forming apparatus 20 on the display screen G of the display unit 12a of the mobile terminal apparatus 10 (see FIG. 13).

The image forming system 100 includes the mobile terminal apparatus 10 and the image forming apparatus 20.

In the present embodiment, the control unit 15 of the mobile terminal apparatus 10 functions as a unit further including a ninth control section Q9 and a tenth control section Q10. In other words, the display control program DP causes the control unit 15 to execute a ninth control step corresponding to the ninth control section Q9 and a tenth control step corresponding to the tenth control section Q10.

At the ninth control step, the control unit 15 transmits image data IM(i) and IM(j) corresponding to chosen thumbnail images SN(i) and SN(j) to the server 30. At the tenth control step, the control unit 15 receives image data IM(i) and IM(j) stored in the database DB of the server 30. The server 30 stores the image data IM(i) and IM(j) transmitted from the mobile terminal apparatus 10 in the database DB.

This allows the user to store the image data IM(i) and IM(j) corresponding to the thumbnail images SN(i) and SN(j) chosen in the mobile terminal apparatus 10 in the database DB of the server 30. The user can receive the image data IM(i) and IM(j) stored in the database DB of the server 30 with the mobile terminal apparatus 10.

Image data IM printed with the image forming apparatus 20 of a first model installed in a first installation site is stored in the database DB of the server 30 in advance. If the image data IM is to be printed with the image forming apparatus 21 of a second model installed in a second installation site, the image forming apparatus 21 may not have the function installed in the image forming apparatus 20.

In this respect, the control unit 15 of the mobile terminal apparatus 10 of the present embodiment can display a preview of an image based on the image data IM stored in the server 30 on the display screen G of the display unit 12a according to the function installed in the image forming apparatus 20. This allows the user to process the image data IM to fit the function installed in the image forming apparatus 20 using the mobile terminal apparatus 10 before transmitting the image data IM stored in the server 30 to the image forming apparatus 20. Thus, the user can transmit the image data IM in the mobile terminal apparatus 10 to the image forming apparatus 20 at one time, which can save the time and labor for the transmission operation.

The present disclosure contains subject matter-related to that disclosed in Japanese Priority Patent Application JP 2018-137602 filed in the Japan Patent Office on Jul. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile terminal apparatus comprising:
a display unit including a display screen;
a display control program for displaying a plurality of thumbnail images respectively corresponding to a plurality of image data on the display screen to allow the plurality of thumbnail images to be chosen on the display screen;
a control unit; and
a storage unit storing the plurality of image data respectively corresponding to the plurality of thumbnail images,
wherein the display control program causes the control unit to execute:
a first control step of displaying the plurality of thumbnail images in a thumbnail display area of the display screen;
a second control step of receiving an operation to choose a thumbnail image in the thumbnail display area in which the plurality of thumbnail images are displayed;
a third control step of displaying an enlarged image of the chosen thumbnail image in an enlarged display area of the display screen, with the chosen thumbnail image kept displayed;
a fourth control step of receiving an operation to change a size of the enlarged display area on the display screen; and
a fifth control step of increasing an enlargement ratio of the enlarged image to fit the size of the enlarged display area when increasing the size of the enlarged display area.

2. The mobile terminal apparatus according to claim 1,
wherein the fifth control step includes decreasing a display number of the thumbnail images by a number corresponding to an increase in the size of the enlarged display area.

3. The mobile terminal apparatus according to claim 1,
wherein the third control step includes displaying the enlarged display area on the thumbnail display area in an overlapping manner.

4. The mobile terminal apparatus according to claim 1,
wherein the fourth control step includes receiving the operation to change the size of the enlarged display area on the display screen, with the chosen thumbnail image kept displayed in the thumbnail display area.

5. The mobile terminal apparatus according to claim 4,
wherein the second control step includes holding a state in which a previously chosen thumbnail image is chosen, and
wherein the fourth control step includes receiving the operation to change the size of the enlarged display area on the display screen, with the chosen thumbnail image and the previously chosen thumbnail image kept displayed in the thumbnail display area.

6. The mobile terminal apparatus according to claim 1,
wherein the fourth control step includes defining a largest display size of the enlarged display area and inhibiting the size of the enlarged display area from exceeding the largest display size.

7. The mobile terminal apparatus according to claim 1,
wherein the fifth control step includes, when decreasing the size of the enlarged display area, decreasing the enlargement ratio of the enlarged image to fit the size of the enlarged display area.

8. The mobile terminal apparatus according to claim 7,
wherein the fifth control step includes increasing a display number of the thumbnail images by a number corresponding to a decrease in the size of the enlarged display area.

9. The mobile terminal apparatus according to claim 1,
wherein the first control step includes setting a size and a position of the thumbnail image to fit a size of the display screen.

10. The mobile terminal apparatus according to claim 1,
wherein the first control step includes setting a display number of the thumbnail images to fit a size of the display screen.

11. The mobile terminal apparatus according to claim 1,
wherein the fourth control step includes setting a predetermined largest display size of the thumbnail display area to fit a size of the display screen.

12. The mobile terminal apparatus according to claim 1, further comprising:
a sixth control step of transmitting image data corresponding to the chosen thumbnail image to an image forming apparatus.

13. The mobile terminal apparatus according to claim 12, further comprising:
a seventh control step of receiving installed function data on a function installed in the image forming apparatus from the image farming apparatus; and
an eighth control step of displaying a preview of an image to be formed based on the image data on the display screen according to the installed function of the image forming apparatus.

14. The mobile terminal apparatus according to claim 13,
wherein the installed function is a function of forming an image on a sheet of a preset specified size, and
wherein the eighth control step includes displaying a preview of the image to be formed based on the image data on the display screen according to the specified size.

15. A method for controlling display of a mobile terminal apparatus displaying a plurality of thumbnail images respectively corresponding to a plurality of image data on a display screen to allow the plurality of thumbnail images to be chosen on the display screen, the method comprising:
a first control step of displaying the plurality of thumbnail images in a thumbnail display area of the display screen;
a second control step of receiving an operation to choose a thumbnail image in the thumbnail display area in which the plurality of thumbnail images are displayed;
a third control step of displaying an enlarged image of the chosen thumbnail image in an enlarged display area of the display screen, with the chosen thumbnail image kept displayed;
a fourth control step of receiving an operation to change a size of the enlarged display area on the display screen; and
a fifth control step of increasing an enlargement ratio of the enlarged image to fit the size of the enlarged display area when increasing the size of the enlarged display area.
